(19) United States
(12) Patent Application Publication
(10) Pub. No.: US 2017/0011426 A1
(43) Pub. Date: Jan. 12, 2017

(54) SYSTEMS AND METHODS FOR IMPLEMENTING PERFORMANCE DRIVEN PRICING FOR ADVERTISING ON VEHICLES

(71) Applicants: MIKHAIL MARCHENKO, Moscow (RU); RASUL AKHMEDOV, Moscow (RU)

(72) Inventors: MIKHAIL MARCHENKO, Moscow (RU); RASUL AKHMEDOV, Moscow (RU)

(21) Appl. No.: 14/795,899

(22) Filed: Jul. 10, 2015

(51) Int. Cl. G06Q 30/02

(52) U.S. Cl. CPC G06Q 30/0266; G06Q 30/0273

(57) ABSTRACT

Described is a computer-implemented method for implementing performance driven pricing for advertising on vehicles by a plurality of users, the method being performed in connection with a computerized system comprising a central processing unit, a positioning device, a display device and a memory, the computer-implemented method comprising: determining a current geographical position information of a user of the plurality of users using the positioning device; determining a current date and time information; determining a current tariff using the central processing unit, wherein the current tariff is determined using a plurality of predetermined coefficients; and determining a number of points awarded to the user of the plurality of users using the central processing unit, wherein the number of points are determined using the current tariff and the spatial distance between the current geographical position information and a past geographical position information. The points represent awards given to the driver for performance.

### BACKGROUND OF THE INVENTION

Technical Field

The disclosed embodiments relate in general to advertising techniques, more specifically, to systems and methods for implementing performance driven pricing for advertising on vehicles.

Description of the Related Art

Transit outdoor advertising, e.g. the advertising content placed on cars, trucks and other road or other surface or air vehicles, such as boats or aircraft, is becoming more end more popular, especially in large metropolitan areas such as New York City, Los Angeles as well as others. Such advertising content may be static, when the content displayed on the vehicle does not change, as in case of permanently affixed stickers or decals, or dynamic, when the vehicle is equipped with an electronic billboard displaying dynamic advertising content, such as video advertisements. In addition, an associated audio content may be provided.

The conventional way of pricing the aforesaid in transit outdoor advertising has always been a fixed price per day per vehicle irrespectively of miles driven, timing of the rides, locations visited, etc. As would be appreciated by persons of ordinary skill in the art, such oversimplified approach to advertising pricing is highly inefficient for advertisers who had no transparent statistics about the performance of the advertising campaign. In addition, the conventional advertising pricing approach was also ineffective for active, performance-driven vehicle drivers who earned the same amount of money as the drivers who didn't drive at all during the campaign or limited their rides to unwanted geographical areas and/or unwanted times.

As would be appreciated by persons of ordinary skill in the art, in view of the above and other deficiencies of the conventional approach to pricing of the aforesaid in transit outdoor advertising, a new and improved approach to pricing determination based on actual driver performance would be highly desirable.

### SUMMARY OF THE INVENTION

The embodiments described herein are directed to methods and systems that substantially obviate one or more of the above and other problems associated with conventional approach to pricing of the in transit outdoor advertising.

In accordance with one aspect of the inventive concepts described herein, there is provided a computer-implemented method for implementing performance driven pricing for advertising on vehicles by a plurality of users, the method being performed in connection with a computerized system incorporating a central processing unit, a positioning device, a display device and a memory, the computer-implemented method including: determining a current geographical position information of a user of the plurality of users using the positioning device; determining a current date and time information; determining a current tariff using the central processing unit, wherein the current tariff is determined using a plurality of predetermined coefficients; and determining a number of points awarded to the user of the plurality of users using the central processing unit, wherein the number of points are determined using the current tariff and the spatial distance between the current geographical position information and a past geographical position information.

In one or more embodiments, the current tariff is determined by multiplying the plurality of predetermined coefficients.

In one or more embodiments, the number of points awarded to the user is determined by multiplying the determined current tariff and the spatial distance between the current geographical position information and a past geographical position information.

In one or more embodiments, the plurality of predetermined coefficients comprises a numeric coefficient reflecting a type of the vehicle associated with the user of the plurality of users.

In one or more embodiments, the plurality of predetermined coefficients comprises a numeric coefficient reflecting the determined current date and time information.

In one or more embodiments, the plurality of predetermined coefficients comprises a numeric coefficient reflecting a type of an advertising medium affixed to the vehicle associated with the user of the plurality of users.

In one or more embodiments, the plurality of predetermined coefficients comprises a numeric coefficient reflecting the determined current geographical position information of the user of the plurality of users.

In one or more embodiments, the method further includes displaying the determined current tariff and the determined number of points awarded to the user on the display device.

In one or more embodiments, all steps of the aforesaid method are performed at periodic time intervals.

In one or more embodiments, the method further includes invalidating points awarded to the user if the spatial distance between the current geographical position information and a past geographical position information exceeds a predetermined threshold.

In one or more embodiments, the method further includes using the central processing unit to aggregate the number of points awarded to the user with points previously awarded to the user.

In one or more embodiments, first and second steps of the aforesaid method are performed by a mobile client device co-located with the user of the plurality of users.

In one or more embodiments, third and fourth steps of the aforesaid method are performed in a server system communicatively coupled with the mobile client device co-located with the user of the plurality of users.

In accordance with another aspect of the inventive concepts described herein, there is provided a computerized system for implementing performance driven pricing for advertising on vehicles by a plurality of users, the computerized system incorporating a central processing unit, a positioning device, a display device and a memory storing a set of computer-executable instructions for: determining a current geographical position information of a user of the plurality of users using the positioning device; determining a current date and time information; determining a current tariff using the central processing unit, wherein the current tariff is determined using a plurality of predetermined coefficients; and determining a number of points awarded to the user of the plurality of users using the central processing unit, wherein the number of points are determined using the current tariff and the spatial distance between the current geographical position information and a past geographical position information.

In one or more embodiments, the current tariff is determined by multiplying the plurality of predetermined coefficients.

In one or more embodiments, the number of points awarded to the user is determined by multiplying the determined current tariff and the spatial distance between the current geographical position information and a past geographical position information.

In one or more embodiments, the plurality of predetermined coefficients comprises a numeric coefficient reflecting a type of the vehicle associated with the user of the plurality of users.

In one or more embodiments, the plurality of predetermined coefficients comprises a numeric coefficient reflecting the determined current date and time information.

In one or more embodiments, the plurality of predetermined coefficients comprises a numeric coefficient reflecting a type of an advertising medium affixed to the vehicle associated with the user of the plurality of users.

In accordance with another aspect of the inventive concepts described herein, there is provided a non-transitory computer-readable medium embodying a set of computer-executable instructions, which, when executed in a computerized system incorporating a central processing unit, a positioning device, a display device and a memory, cause the computerized system to perform a method for implementing performance driven pricing for advertising on vehicles by a plurality of users, the method including: determining a current geographical position information of a user of the plurality of users using the positioning device; determining a current date and time information; determining a current tariff using the central processing unit, wherein the current tariff is determined using a plurality of predetermined coefficients; and determining a number of points awarded to the user of the plurality of users using the central processing unit, wherein the number of points are determined using the current tariff and the spatial distance between the current geographical position information and a past geographical position information.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates and exemplary logical diagram of an embodiment of a complete system for implementing performance driven pricing for advertising on vehicles.

FIG. 2 illustrates exemplary internal data flows between the system components shown in the exemplary logical diagram of the inventive system for implementing performance driven pricing for advertising on vehicles illustrated in FIG. 1.

FIG. 3 illustrates an exemplary block diagram of an embodiment of a software algorithm executed in connection with the inventive system for implementing performance driven pricing for advertising on vehicles illustrated in FIG. 1.

FIGS. 4 and 5 illustrate two exemplary embodiments of a graphical user interface screens of an embodiment of an inventive system for implementing performance driven pricing for advertising on vehicles.

FIG. 6 illustrates an exemplary embodiment of a computerized mobile system that could be used as the user's client device in connection with the system shown in FIG. 1.

FIG. 7 illustrates an exemplary embodiment of a computerized server system, which could be used, for example, as the server of the inventive system for implementing performance driven pricing for advertising on vehicles shown in FIG. 1.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

To address the above and other problems associated with the conventional technology, one or more embodiments described herein implement various exemplary systems and methods for implementing performance driven pricing for advertising on vehicles. Specifically, in accordance with one aspect of the inventive techniques, there is provided an internal measure of activity for drivers called “point”. In one embodiment, this measure is equal to miles driven by the driver multiplied by number of predetermined coefficients. However, it should be noted that other alternative ways for calculating the aforesaid points possible and, therefore, the invention is not limited to only the described specific ways. In various embodiments points may represent the internal measure of driver's performance and may also represent awards given to the driver for his or her performance. The awards may include monetary or non-monetary awards, such as monetary payments made to the user's bank account.

In accordance with another aspect of the inventive techniques, there is provided a mobile application which automatically computes the aforesaid points for each driver, and, based on these calculated points determines the amount of compensation for each driver. Therefore, the described embodiment of the invention establishes a fair performance driven pricing system for both drivers and advertisers.

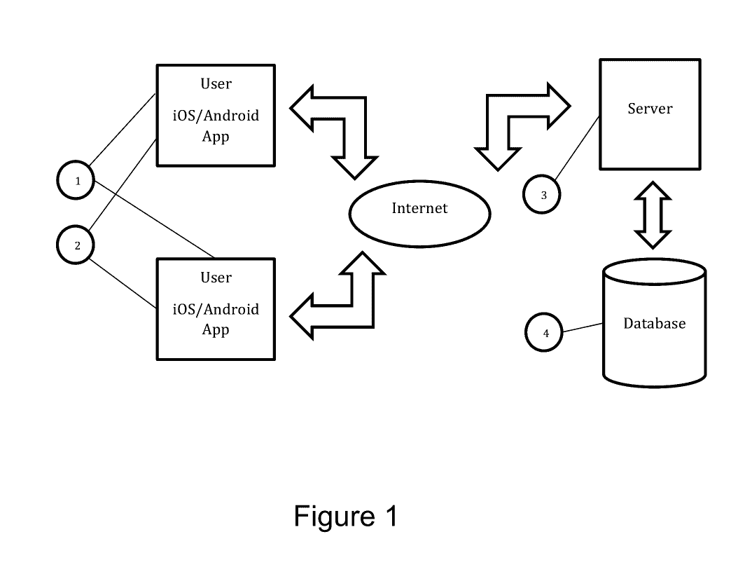

FIG. 1 illustrates and exemplary logical diagram of an embodiment of a complete system for implementing performance driven pricing for advertising on vehicles. As shown in FIG. 1, one or more users 1 of the system for implementing performance driven pricing is a typically a driver of a car or other vehicle who participates in an advertising campaign by placing advertising sticker(s), decal(s) and/or electronic display device(s), such as electronic billboard(s) displaying dynamic advertising content, on his or her car or other type of vehicle. In one or more embodiments, each of the users 1 is provided with a user client device 2, such as a smartphone. Each user 1 uses the corresponding client device 2 to communicate with other elements of the system for implementing performance driven pricing for advertising on vehicles shown in FIG. 1.

In one or more embodiments, the client device 2 is a smartphone running a mobile operating system such as iOS or Android, as well as an inventive mobile application described in detail below. In one or more embodiments, this inventive mobile application may be continually in an active execution mode and at certain predetermined time intervals (for example once per every second) it may use one or more positioning sensors, such as GPS sensors, well known to persons of ordinary skill in the art, to compute the current geographical (geo) position of the client device 2 used by the driver 1 and send the computed location information to a server 3 via a wireless transmission channel.

In one or more embodiments, as shown in FIG. 1, the inventive system for implementing performance driven pricing for advertising on vehicles further incorporates a server 3 operatively connected via a data transmission network with other components of the aforesaid system. In one embodiment, the server 3 is configured to receive, collect and store data, such as the aforesaid geographic position data, from client devices 2 of all drivers 1 and perform all the necessary computations in accordance with the algorithms described in detail below. In various embodiments, the server 3 may be a physical server or a virtual or cloud-based server.

In one or more embodiments, the communication between the client devices 2 and the server 3 is performed in a form of network requests and responses, which may or may not contain associated data and which may be sent using any now known or later developed network communication protocol, such as HTTP. To this end, the server 3 may include a web service portion (not shown) in order to receive and handle the incoming requests and data from client devices 2. By way of example and not limitation, the web service portion may be implemented using Apache web server, Microsoft Windows Server, Sun web server, Google web server, and/or Nginx web server, all of which are well known to persons of ordinary skill in the art, or any other suitable now known or later developed web server product.

In one or more embodiments, as shown in FIG. 1, the inventive system for implementing performance driven pricing for advertising on vehicles further incorporates a database engine 4 operatively coupled with the server 3 via a data transmission network or other suitable data transmission interconnect. In one embodiment, the database engine 4 may be co-located with the sever 3. In an alternative embodiment, the database engine 4 may be remotely deployed or deployed in a cloud. In one embodiment, the database engine 4 stores in one or more associated database tables and manages access to all information about the parameters of advertising campaigns, including, without limitation, multiples for different geographical zones, car or other vehicle types, date and time information as well as other parameters of the advertising campaign. As would be appreciated by persons of ordinary skill in the art, many types of data may be relevant to the advertising campaign and the inventive concepts described herein are not limited to any specific data items or types.

In various embodiments, the database engine 4 may be implemented based on any now known or later developed type of database management system, such as a relational database management system, including, without limitation, MySQL, Oracle, SQL Server, DB2, SQL Anywhere, PostgreSQL, SQLite, Firebird, redis, MongoDB, Hadoop and/or MaxDB, which are well-known to persons of skill in the art. In an alternative embodiment, a cloud-based distributed database, such as Amazon Relational Database Service (Amazon RDS), well known to persons of ordinary skill in the art, may also be used in place of the integrated database engine 4.

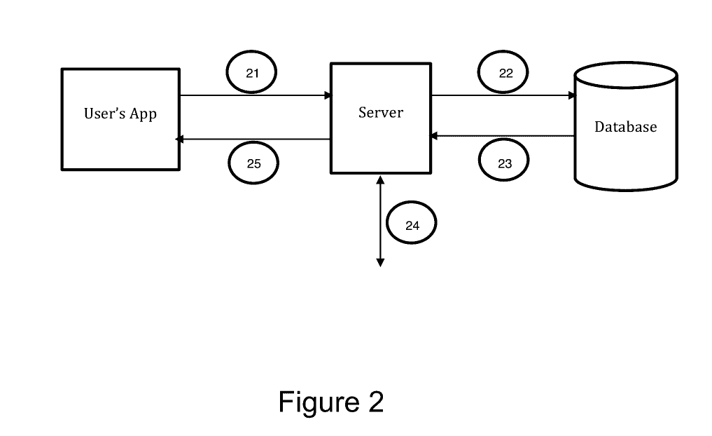

FIG. 2 illustrates exemplary internal data flows between the system components shown in the exemplary logical diagram of the inventive system for implementing performance driven pricing for advertising on vehicles illustrated in FIG. 1. Specifically, a data flow element 21 sent by the client device 2 to the server 3, as shown in FIG. 2, may for example include, without limitation, the current geographical positioning data of the client device 2 obtained from global positioning system (GPS) of the client device 2 and a user identifier (ID) of the user 1 of the client device 2. In one embodiment, these data 21 may be sent by the inventive mobile application executing on the client device 2 at predetermine time intervals. One such exemplary time interval is one second. As would be appreciated by persons of ordinary skill in the art, the aforesaid time interval is exemplary only and may be adjusted down if one needs more up to date location data or up if one needs to reduce load of the server and/or data network.

In one or more embodiments, the data flow element 22 shown in FIG. 2 is a request for all coefficients necessary to compute current multiple for a specific user ID given current geographical position, date and time. Subsequently, the new geographical positioning information for specific user ID is stored in the database 4.

In one or more embodiments, the data flow element 23 shown in FIG. 2 is a request issued by the server 3 to the database engine 4 to look up a specified user ID in one or more database tables managed by the database engine 4 and provide to the server 3 one or more of the following exemplary parameters associated with that user ID:
C—a numeric coefficient which corresponds to a type of user's car or other vehicle;
T—a numeric coefficient, which corresponds to the current date and time according to settings of the advertising campaign, in which the user associated with the specified user ID participates. In various embodiments, each calendar day may be subdivided into multiple predetermined time intervals (periods) and each such time interval of the day may be pre-assigned its own coefficient. Moreover, in various embodiments, same time intervals of different days may have different coefficients.
S—a numeric coefficient, which corresponds to the type of a sticker or other advertising medium (e.g. electronic billboard) of the selected user according to the settings of the advertising campaign. In various embodiments, as would be appreciated by persons of ordinary skill in the art, each type of a sticker or other advertising medium applied on the car or other vehicle of the user may have its own coefficient.
Z—a numeric coefficient, which corresponds to the current geographical position of the user according to the settings of the advertising campaign. In various embodiments, a specific geographical area of the advertising campaign may be subdivided into a predetermined number of geographical zones, such as cities, districts, streets, etc., and each such geographical zone may be assigned a specific coefficient.

In one or more embodiments, in the data flow element 24 shown in FIG. 2, the server 3 computes current Tariff and Points based on received C, T, S, Z coefficients described above according to the following formula:

Tariff=C×T×S×Z.

On the other hand, points given to the specific user are computed according to the following formula:

Points={a distance between the current geographical position received from user's client device and the previous such geographical position}×Tariff.

In one or more embodiments, after computing the Tariff and the Points as described above, the server 3 is configured to add the computed Points to the sum of all points earned by the specific user to date.

In one or more embodiments, in the data flow element 25 shown in FIG. 2, the server 3 sends the calculated Tariff and Points to the inventive mobile application executing on the user's client device 2 to display to the user the current tariff and to update total number of points earned by user in current ride as well as the total balance of points of the user. This information is displayed to the user by the inventive mobile application executing on the user's client device 2.

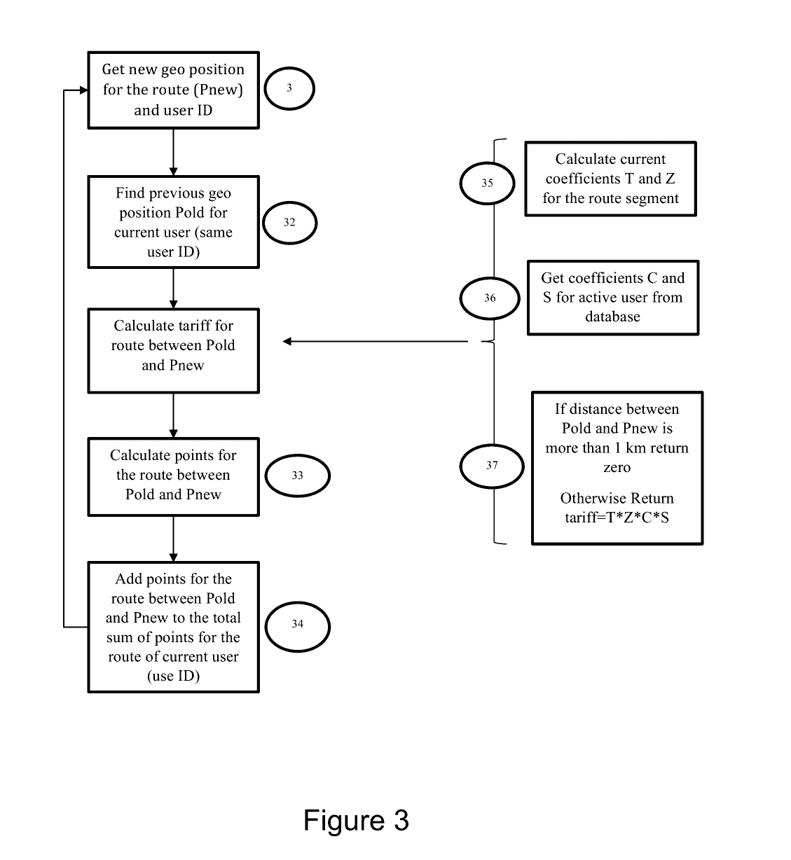

FIG. 3 illustrates an exemplary block diagram of an embodiment of a software algorithm executed in connection with the inventive system for implementing performance driven pricing for advertising on vehicles illustrated in FIG. 1. First, at step 31, the server 3 receives new geographical point position(s) from inventive mobile applications executed by user's client device(s), as illustrated in mode detail in FIG. 2. The server 3 of the system processes the received geographical position information using the algorithm described in connection with this FIG. 3. In one embodiment, the input information that the algorithm illustrated in FIG. 3 receives is geographical position (and time) of the user's client device 2 as well as the corresponding user ID. In one embodiment, the geographical position may include longitude, latitude and time information determined by the GPS unit of client device 2 (e.g. a smartphone).

At step 32, the system uses the received user ID to lookup the previously reported geographical position of the user (user's client device 2) by means of the database engine 4.

At step 33, the server 3 of the system calculates the points to be awarded to the user 1 using the formula described above in connection with FIG. 2, and, specifically, Points={a distance between the current geographical position received from user's client device and the previous such geographical position}×Tariff.

Subsequently, at step 34, the so calculated points for the new segment of the route of the user's vehicle are added to the total points of the route corresponding to the user ID in the database 4 and the algorithm returns to the first step thereof.

At step 35, the server is configured to determine the aforesaid T coefficients based on the date and time portions of Pnew and Pold geographical positions (which include date and time) retrieved using the database engine 4. The average of the values thereof is then returned. The same is done for the aforesaid Z coefficient. It should be noted that the values of T and Z for Pnew and Pold can be different if the user was crossing borders of geographical zones or time periods of the day, as described in connection with step 23 above.

At step 36, the values of the coefficients C and S, which are constant for each user ID in the current advertising campaign, are retrieved by means of the database engine 4.

At step 37, an anti-fraud mechanism is applied and all route segments are marked as invalid if the distance between subsequent geographical positions is more than a predetermined value (e.g. 1 kilometer), which may be adjusted depending on the target city's public transport system as a part of setting up the parameters od the advertising campaign. This anti-fraud mechanism helps to prevent usage by unscrupulous users of the described inventive mobile application in public transport, such as high-speed trains or metro subway instead of a bona-fide car displaying the advertisements.

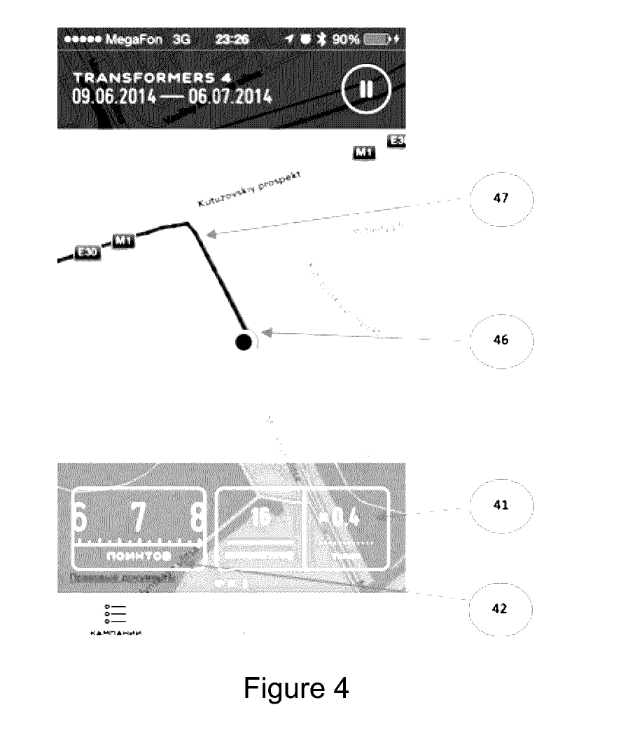

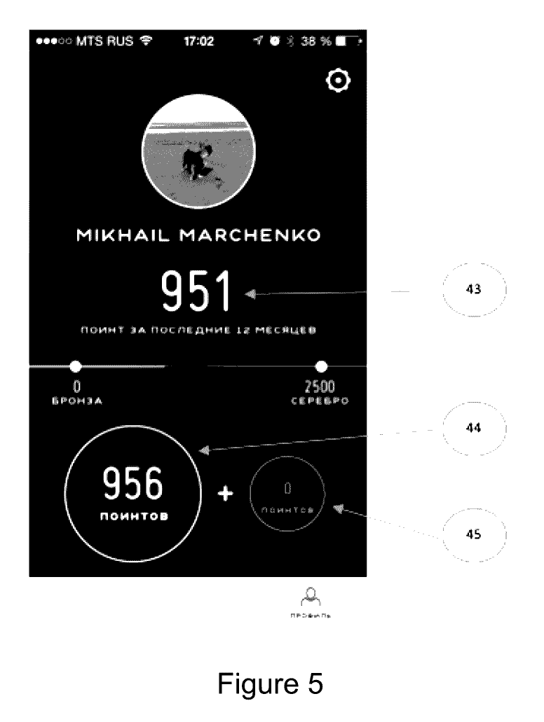

FIGS. 4 and 5 illustrate two exemplary embodiments of a graphical user interface screens of an embodiment of an inventive system for implementing performance driven pricing for advertising on vehicles. The aforesaid graphical user interface screens may be displayed on a display device of the client device 2 of the user 1 (driver) as shown in FIG. 1. In various embodiments, the displayed graphical user interface screens may consist of various portions containing specific information provided to the driver.

For example, in one or more embodiments, a portion 41 of the graphical user interface screen shown in FIG. 4 may display to the user the current Tariff computed by server 3, as described in connection with the data flow element 24 shown in the FIG. 2 above.

Similarly, in one or more embodiments, a portion 42 of the graphical user interface screen shown in FIG. 4 may display to the user a total number of points earned by the user during the current ride, as described in connection with data flow element 25 above.

Moreover, in one or more embodiments, a portion 43 of the graphical user interface screen shown in FIG. 5 may display to the total number of points earned by the user during the last 12 months. In one embodiment, the system may compute the user's status based on the total number of points, wherein more points (e.g. higher user status) result in a better exchange rate of points into money).

Moreover, in one or more embodiments, a portion 44 of the graphical user interface screen shown in FIG. 5 may display to the user the current balance of verified points. Similarly, a portion 45 of the graphical user interface screen shown in FIG. 5 may display to the user the current balance of unverified points.

Moreover, in one or more embodiments, a portion 46 of the graphical user interface screen shown in FIG. 4 may display the current location of user, determined by the inventive mobile application executing on the client device 2 of the user. As described above in connection with data flow item 21, this position data is sent from the client device 2 to the server 3. Finally, and in a similar manner, the portion 47 of the graphical user interface screen shown in FIG. 4 may display the route completed by the user during current the ride (drive).

### Computing Platforms

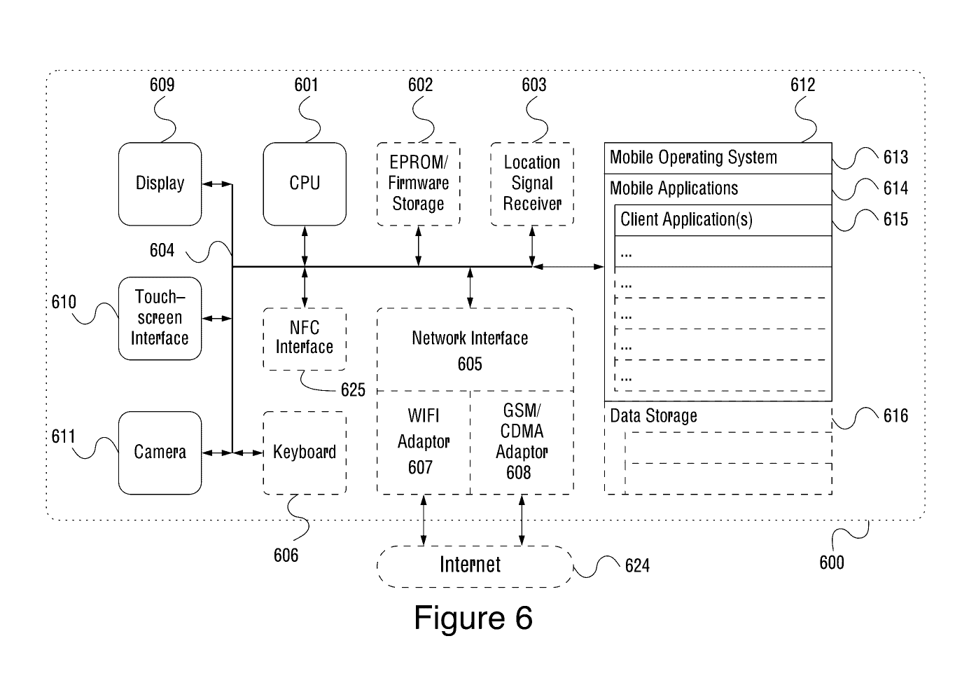

FIG. 6 illustrates an exemplary embodiment of a computerized mobile system 600 that could be used as the user's client device 1 in connection with the system shown in FIG. 1. In one or more embodiments, the computerized mobile system 600 may be implemented within a form factor of a mobile computing device, such as a smartphone, a personal digital assistant (PDA), a tablet computer, or a smart watch, all of which are widely available commercially and are well known to persons of skill in the art.

The computerized system 600 may include a data bus 604 or other interconnect or communication mechanism for communicating information across and among various hardware components of the mobile computerized system 600, and a central processing unit (CPU or simply processor) 601 coupled with the data bus 604 for processing information and performing other computational and control tasks. Computerized system 600 also includes a memory 612, such as a random access memory (RAM) or other dynamic storage device, coupled to the data bus 604 for storing various information as well as instructions to be executed by the processor 601. The memory 612 may also include persistent storage devices, such as a magnetic disk, optical disk, solid-state flash memory device or other non-volatile solid-state storage devices.

In one or more embodiments, the memory 612 may also be used for storing temporary variables or other intermediate information during execution of instructions by the processor 601. Optionally, computerized system 600 may further include a read only memory (ROM or EPROM) 602 or other static storage device coupled to the data bus 604 for storing static information and instructions for the processor 601, such as firmware necessary for the operation of the computerized system 600, basic input-output system (BIOS), as well as various configuration parameters of the computerized system 600.

In one or more embodiments, the computerized system 600 may incorporate a display device 609, which may be also coupled to the data bus 604, for displaying various information to a user of the computerized system 600, such as the user interface screens shown in FIGS. 4 and 5. In an alternative embodiment, the display device 609 may be associated with a graphics controller and/or graphics processor (not shown). The display device 609 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 609 may be incorporated into the same general enclosure with the remaining components of the computerized system 600. In an alternative embodiment, the display device 609 may be positioned outside of such enclosure.

In one or more embodiments, the computerized system 600 may further incorporate an near field communication (NFC) interface 625 connected to the data bus 604 and configured to communicate with one or more NFC devices for determining its geographical position.

In one or more embodiments, the computerized system 600 may incorporate one or more input devices, such as a touchscreen interface 610 for receiving tactile commands, a camera 611 for acquiring still images and video of various objects, as well as a keyboard 606, which all may be coupled to the aforesaid data bus 604 for communicating information, including, without limitation, images and video, as well as user command selections to the processor 601. In an alternative embodiment, input devices may include a system for tracking eye movements of the user (not shown), which may be used to indicate to the computerized system 600 the command selection by the user.

In one or more embodiments, the computerized system 600 may additionally include a location signal receiver 603 configured to perform scan for GPS signal or beacons and supply scan data described above to the processor 601 via the data bus 604.

In one or more embodiments, the computerized system 600 may additionally include a communication interface, such as a network interface 605 coupled to the data bus 604. The network interface 605 may be configured to establish a connection between the computerized system 600 and the Internet 624 using at least one of WIFI interface 607 and the cellular network (GSM or CDMA) adaptor 608. The network interface 605 may be configured to provide a two-way data communication between the computerized system 600 and the Internet 624. The WIFI interface 607 may operate in compliance with 802.11a, 802.11b, 802.11g and/or 802.11n protocols as well as Bluetooth protocol well known to persons of ordinary skill in the art. In an exemplary implementation, the WIFI interface 607 and the cellular network (GSM or CDMA) adaptor 608 send and receive electrical or electromagnetic signals that carry digital data streams representing various types of information.

In one or more embodiments, the Internet 624 typically provides data communication through one or more sub-networks to other network resources. Thus, the computerized system 600 is capable of accessing a variety of network resources located anywhere on the Internet 624, such as web servers, other content servers as well as other network data storage resources. In one or more embodiments, the computerized system 600 is configured send and receive messages, media and other data, including application program code, through a variety of network(s) including Internet 624 by means of the network interface 605. In the Internet example, when the computerized system 600 acts as a network client, it may request code or data for an application program executing on the computerized system 600. Similarly, it may send various data or computer code to other network resources.

In one or more embodiments, the computerized system 600 uses the network interface 605 to send request(s), via the Internet 624, such as HTTP requests, to the servers 3 and receive various information, including, without limitation, the aforesaid information displayed to the user using the user interface shown in FIGS. 4 and 5.

In one or more embodiments, the functionality described herein is implemented by computerized system 600 in response to processor 601 executing one or more sequences of one or more instructions contained in the memory 612. Such instructions may be read into the memory 612 from another computer-readable medium. Execution of the sequences of instructions contained in the memory 612 causes the processor 601 to perform the various process steps described herein. In alternative embodiments, hard-wired circuitry may be used in place of or in combination with software instructions to implement the embodiments of the invention. Thus, embodiments of the invention are not limited to any specific combination of hardware circuitry and software.

The term “computer-readable medium” as used herein refers to any medium that participates in providing instructions to processor 601 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to processor 901 for execution. For example, the instructions may initially be carried on a magnetic disk from a remote computer. Alternatively, a remote computer can load the instructions into its dynamic memory and send the instructions over the Internet 624. Specifically, the computer instructions may be downloaded into the memory 612 of the computerized system 600 from the foresaid remote computer via the Internet 624 using a variety of network data communication protocols well known in the art.

In one or more embodiments, the memory 612 of the computerized system 600 may store any of the following software programs, applications or modules:

1. Operating system (OS) 613, which may be a mobile operating system for implementing basic system services and managing various hardware components of the computerized system 600. Exemplary embodiments of the operating system 613 are well known to persons of skill in the art, and may include iOS, Android, Windows Mobile or any other now known or later developed mobile operating system(s).

2. Mobile applications 614 may include, for example, a set of software applications executed by the processor 601 of the computerized system 600, which cause the computerized mobile system 600 to perform certain predetermined functions, such as receive the GPS position data and transmit it to the server 3, to receive information for displaying to the user and to display this information to the user using the graphical user interface displayed on the display device as described above in connection with FIGS. 4 and 5. In one or more embodiments, the mobile applications 614 may include, for example, the client application 615.

3. Data storage 616 may be used, for example, for storing client device location information as well as other data, such as points earned by the user, distance traveled, trip duration as well as other suitable statistical information.

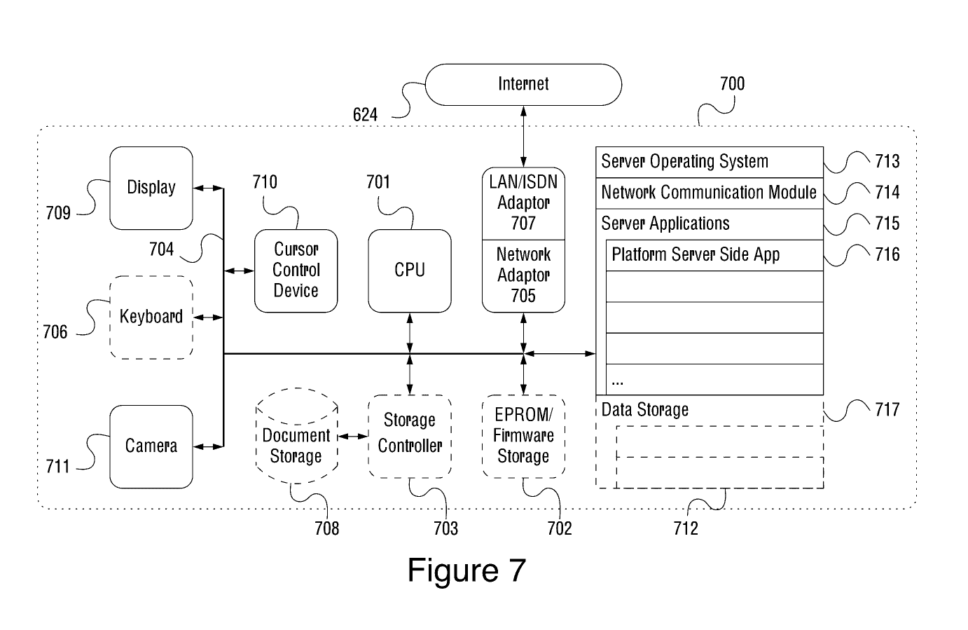

FIG. 7 illustrates an exemplary embodiment of a computerized server system 700 which could be used, for example, as the server 3 of the inventive system for implementing performance driven pricing for advertising on vehicles shown in FIG. 1. It should be noted that other components of the described system such as the database engine 4 may be also deployed on the computerized server system 700.

In one or more embodiments, the computerized server system 700 may incorporate a data bus 704, which may be substantially similar and may perform substantially similar functions as the data bus 704 of the computerized system 600 illustrated in FIG. 6. In various embodiments, the data bus 704 may use the same or different interconnect and/or communication protocol as the data bus 604. The one or more processors (CPUs) 701, the network adaptor 705, the EPROM/Firmware storage 702, the display device 709 and the keyboard 706 of the computerized server system 700 may be likewise substantially similar to the respective processor 601, the network interface 605, the EPROM/Firmware storage 602, the display device 609 and the keyboard 606 of the computerized system 600, except that the former components are deployed in a server platform configuration. In various implementations, the one or more processor 701 may have substantially increased processing power as compared with the processor 601.

In addition to the input device 706 (keyboard), the computerized server system 700 may additionally include a cursor control device 710, such as a mouse, a trackball, or cursor direction keys for communicating direction information and command selections to processor 701 and for controlling cursor movement on the display device 709. This input device typically has two degrees of freedom in two axes, a first axis (e.g., x) and a second axis (e.g., y), that allows the device to specify positions in a plane.

The LAN/ISDN adaptor 707 of the computerized server system 700 may be implemented, for example, using an integrated services digital network (ISDN) card or a modem to provide a data communication connection to a corresponding type of telephone line, which is interfaced with the Internet 624 using Internet service provider's hardware (not shown). As another example, the LAN/ISDN adaptor 707 may be a local area network interface card (LAN NIC) to provide a data communication connection to a compatible LAN and the Internet 624. To store various data files, the computerized server system 700 may be provided with data storage 708, for storing various statistical data to be displayed to the user by means of a storage controller 703. The camera 711 may be used to acquire images and/or video of various objects.

In one or more embodiments, the memory 712 of the computerized server system 700 may store any of the following software programs, applications, modules and/or data:

1. A server operating system (OS) 713, which may be an operating system for implementing basic system services and managing various hardware components of the computerized server system 700. Exemplary embodiments of the server operating system 713 are all well known to persons of skill in the art, and may include Windows Server, Mac OS, Unix, AIX, FreeBSD, Linux, as well as any now known or later developed operating systems.

2. A network communication module 714 may incorporate, for example, one or more network protocol stacks which are used to establish a networking connection between the computerized server system 700 and the various network entities of the Internet 624, such as the computerized mobile system 600, using the network adaptor 705 working in conjunction with the LAN/ISDN adaptor 707.

3. Server applications 615 may include, for example, a set of software applications executed by one or more processors 701 of the computerized server system 700, which cause the computerized server system 700 to perform certain predetermined functions or tasks. In one or more embodiments, the server applications 715 may include the server side application 716, the functionality of which was described in detail above. Additionally provided may be a database management system 717 for storing and managing access to various information as described in detail above.

4. Data storage 719 may be used, for example, for storing the user data, the geographical position data, the tariff data, the user point data, as well as any other data items described above, which may be stored in a form of one or more database tables containing database records.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for implementing performance driven pricing for advertising on vehicles. It is intended that the specification and examples be considered as exemplary only, with a true scope and spirit of the invention being indicated by the following claims.

What is claimed is:

1. A computer-implemented method for implementing performance driven pricing for advertising on vehicles by a plurality of users, the method being performed in connection with a computerized system comprising a central processing unit, a positioning device, a display device and a memory, the computer-implemented method comprising:
a. determining a current geographical position information of a user of the plurality of users using the positioning device;
b. determining a current date and time information;
c. determining a current tariff using the central processing unit, wherein the current tariff is determined using a plurality of predetermined coefficients; and
d. determining a number of points awarded to the user of the plurality of users using the central processing unit, wherein the number of points are determined using the current tariff and the spatial distance between the current geographical position information and a past geographical position information.

2. The computer-implemented method of claim 1, wherein the current tariff is determined by multiplying the plurality of predetermined coefficients.

3. The computer-implemented method of claim 1, wherein the number of points awarded to the user is determined by multiplying the determined current tariff and the spatial distance between the current geographical position information and a past geographical position information.

4. The computer-implemented method of claim 1, wherein the plurality of predetermined coefficients comprises a numeric coefficient reflecting a type of the vehicle associated with the user of the plurality of users.

5. The computer-implemented method of claim 1, wherein the plurality of predetermined coefficients comprises a numeric coefficient reflecting the determined current date and time information.

6. The computer-implemented method of claim 1, wherein the plurality of predetermined coefficients comprises a numeric coefficient reflecting a type of an advertising medium affixed to the vehicle associated with the user of the plurality of users.

7. The computer-implemented method of claim 1, wherein the plurality of predetermined coefficients comprises a numeric coefficient reflecting the determined current geographical position information of the user of the plurality of users.

8. The computer-implemented method of claim 1, further comprising displaying the determined current tariff and the determined number of points awarded to the user on the display device.

9. The computer-implemented method of claim 1, wherein steps a. through d. are performed at periodic time intervals.

10. The computer-implemented method of claim 1, further comprising invalidating points awarded to the user if the spatial distance between the current geographical position information and a past geographical position information exceeds a predetermined threshold.

11. The computer-implemented method of claim 1, further comprising using the central processing unit to aggregate the number of points awarded to the user with points previously awarded to the user.

12. The computer-implemented method of claim 1, wherein steps a. and b. are performed by a mobile client device co-located with the user of the plurality of users.

13. The computer-implemented method of claim 1, wherein steps c. and d. are performed in a server system communicatively coupled with the mobile client device co-located with the user of the plurality of users.

14. A computerized system for implementing performance driven pricing for advertising on vehicles by a plurality of users, the computerized system comprising a central processing unit, a positioning device, a display device and a memory storing a set of computer-executable instructions for:
a. determining a current geographical position information of a user of the plurality of users using the positioning device;
b. determining a current date and time information;
c. determining a current tariff using the central processing unit, wherein the current tariff is determined using a plurality of predetermined coefficients; and
d. determining a number of points awarded to the user of the plurality of users using the central processing unit, wherein the number of points are determined using the current tariff and the spatial distance between the current geographical position information and a past geographical position information.

15. The computerized system of claim 14, wherein the current tariff is determined by multiplying the plurality of predetermined coefficients.

16. The computerized system of claim 14, wherein the number of points awarded to the user is determined by multiplying the determined current tariff and the spatial distance between the current geographical position information and a past geographical position information.

17. The computerized system of claim 14, wherein the plurality of predetermined coefficients comprises a numeric coefficient reflecting a type of the vehicle associated with the user of the plurality of users.

18. The computerized system of claim 14, wherein the plurality of predetermined coefficients comprises a numeric coefficient reflecting the determined current date and time information.

19. The computerized system of claim 14, wherein the plurality of predetermined coefficients comprises a numeric coefficient reflecting a type of an advertising medium affixed to the vehicle associated with the user of the plurality of users.

20. A non-transitory computer-readable medium embodying a set of computer-executable instructions, which, when executed in a computerized system comprising a central processing unit, a positioning device, a display device and a memory, cause the computerized system to perform a method for implementing performance driven pricing for advertising on vehicles by a plurality of users, the method comprising:
a. determining a current geographical position information of a user of the plurality of users using the positioning device;
b. determining a current date and time information;
c. determining a current tariff using the central processing unit, wherein the current tariff is determined using a plurality of predetermined coefficients; and
d. determining a number of points awarded to the user of the plurality of users using the central processing unit, wherein the number of points are determined using the current tariff and the spatial distance between the current geographical position information and a past geographical position information.
